(19) United States
(12) Patent Application Publication
(10) Pub. No.: US 2015/0001317 A1
(43) Pub. Date: Jan. 1, 2015

(54) WATER ABSORBING APPARATUS FOR WATER SPRAY CONTAINER

(71) Applicant: CHUANG WEI, TAIPEI CITY (TW)

(72) Inventor: CHUANG WEI, TAIPEI CITY (TW)

(21) Appl. No.: 13/928,545

(22) Filed: Jun. 27, 2013

(51) Int. Cl. B05B 11/00

(52) U.S. Cl. CPC B05B 11/0059
USPC 239/375

(57) ABSTRACT

A water absorbing apparatus for a water spray container is detachably installed at an internal of the water spray container. The container comprises a spray nozzle, a pressure handle provided at a front of the spray nozzle and a suction tube connected to a bottom of the spray nozzle. The water absorbing apparatus is made of a porous material with good water absorption. The water absorbing apparatus comprises a cutting slot to allow the suction tube at the bottom of the spray nozzle to insert therein such that the water absorbing apparatus is attached to an outer of the suction inlet at the rear of the suction tube. With the absorption of the water absorbing apparatus, the suction inlet of the suction tube is maintained at a saturation state such that when the container is placed upside down or tilted, the liquid inside the container can be sprayed out successfully.

### BACKGROUND OF THE INVENTION

1. Technical field

The present invention is related to a water absorbing apparatus for a water spray container, which can be detachably installed at an inner portion of the water spray container to allow a suction inlet of a suction tube inside the water spray container to be maintained at a water saturation state such that when the container is placed upside down or at any tilting angle, the liquid can be sprayed out successfully via pressing a pressure handle thereof and such that the spraying operation of the water spray container is more convenient and more effective as merits and scopes of the improved water spray container.

2. Description of Related Art

Water spray containers capable of spraying out the liquid contained inside the container by ways of water spraying jets or moistures are widely used for such as gardening water sprays and sculpture water sprays. As the liquids contained inside the containers are being protected from the hands of users, they can also be used as spraying containers for various chemical components such as dirt removal agents, lubricants and hygiene cleaning liquids.

Traditionally water spray containers are typically of the structure including a container opening end installed with a spray nozzle having a small piston pump arranged therein, which also includes a pressure handle installed on the spray nozzle, a suction tube connected to the bottom of the spray nozzle, and the suction tube extends inside the container to absorb the liquid therein. Depending upon the type of the liquid, the container can be made of different materials and various shapes; in addition, the pressure handle can also be made of different structures such as finger-pressing type, pressure pressing type or pulling handle type. Since such water spray containers are equipped with an opening top cover, filling of the liquid for the containers can be performed at any time for continued usages.

During the actual operations of the aforementioned traditional water spray containers and if the container is placed in an upright vertical position, the water absorbing end of the suction tube can be maintained in contact with the liquid and the user is able to eject the water spray successfully by pressing down the pressure handle on the spray nozzle to allow the small piston pump to work properly. However, in another situation where due to the needs of operation, the container needs to be tilted or placed upside down in a reverse direction, then the water absorbing end of the suction tube would extend over the top of the liquid surface, during which the pressing of the pressure handle would only suck the air into the suction tube without successfully absorbing the liquid, and the container needs to reversed to the upright position with a few more presses on the pressure handle to allow the suction tube to return to its proper water supplying. Therefore, such structure is inconvenient to the operation and usage thereof.

### SUMMARY OF THE INVENTION

To overcome the aforementioned drawbacks, the present invention provides an improved water absorbing apparatus for a water spray container.

In other words, a primary objective of the present invention is to provide a water absorbing apparatus for a water spray container, which can be detachably installed at an inner portion of the water spray container to allow a suction inlet of a suction tube inside the water spray container to be maintained at a water saturation state such that when the container is placed upside down or at any tilting angle, the liquid can be sprayed out successfully via pressing a pressure handle thereof and such that the spraying operation of the water spray container is more convenient and more effective.

To achieve the aforementioned objectives, the present invention utilizes the following means.

The water absorbing apparatus for a water spray container of the present invention is being detachably installed in an inner portion of the water spray container.

The water spray container comprises a spray nozzle, a pressure handle provided at a frond end of the spray nozzle and a suction tube connected to a bottom portion of the spray nozzle. The spray nozzle is detachably and rotatably secured onto a container opening end such that the spray nozzle can be opened at any time for filling a liquid into the container or for installing/replacing the water absorbing apparatus.

The water absorbing apparatus is made of a porous material with good water absorption, and the water absorbing apparatus comprises a cutting slot to allow the suction tube at the bottom portion of the spray nozzle to insert therein such that the water absorbing apparatus is attached to an outer portion of a suction inlet at the rear end of the suction tube.

By using the water absorption and retaining properties of the water absorbing apparatus, the suction inlet of the suction tube can be kept to maintain at a water saturation state, which significantly strengthens the water absorption of the suction tube, such that when the water spray container is placed upside down or at any tilting angles, the internal of the water absorbing apparatus is saturated with the liquid in order to allow the liquid to be successfully sprayed out from the container.

If the water spray container is under an operation state of being placed upside down for a long period of time and the amount of the liquid inside the water absorbing apparatus becomes less, the user only needs to place the water spray container back to its upright position, the internal of the water absorbing apparatus can then be refilled with the liquid again in a short period of time without affecting the spraying operation.

Since the water absorbing apparatus is of a simple structure, it allows easy DIY operations of users to install the water absorbing apparatus at the rear end of the suction tube inside the water spray container such that the water absorption of the suction tube inside the water spray container is strengthened, which is best suited for applications such as the water spray containers for gardening water sprays, sculpture water sprays, household dirt removal agents, lubricants and cleaning agents, such that the spraying operation of these water spray containers is more convenient and effective in light of achieving the aforementioned objectives of the present invention.

### DESCRIPTION OF THE DRAWINGS

FIG. 1 is an illustration showing the outer appearance of an embodiment of the water spray container of the present invention.

FIG. 2 is an exploded view of the components of the present invention.

FIG. 3 is an enlarged view of the water absorbing apparatus and the suction tube of the present invention.

FIG. 4 is a cross sectional view of the water spray container with the water absorbing apparatus of the present invention installed thereon.

FIG. 5 is an illustration showing the second embodiment of the water absorbing apparatus of the present invention.

FIG. 6 is an illustration showing the third embodiment of the water absorbing apparatus of the present invention.

### DESCRIPTION OF NUMERALS

10 container
11 opening end
12 spray nozzle
13 pressure handle
14 suction tube
15 water outlet
16 suction inlet
20 water absorber
21 cutting slot

### DESCRIPTION OF THE EMBODIMENTS OF THE INVENTION

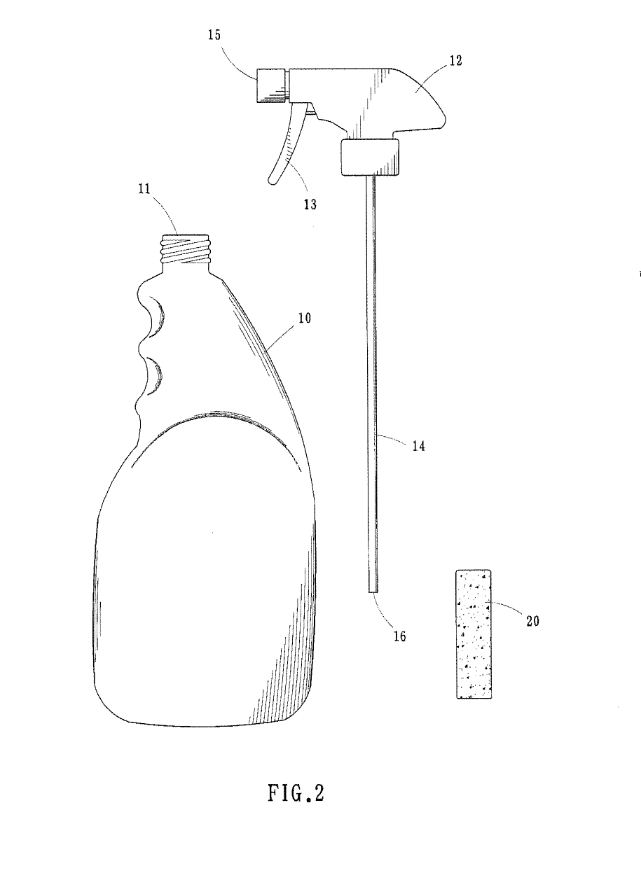

As shown in FIG. 2 enclosed, the water absorbing apparatus 20 for a water spray container of the present invention is detachably installed at an inner portion of a container 10.

As shown in FIG. 2, the container 10 comprises a spray nozzle 12 detachably installed on an container opening end 11, a piston pump pre-installed inside the spray nozzle 12, a pressure handle 13 provided at a front end of the spray nozzle 12, a water outlet 15 with a rotatable adjuster provided at a top of the pressure handle 13 and a suction tube 14 connected to a bottom portion of the spray nozzle 12.

The spray nozzle 12 is detachably and rotatably secured onto the container opening end 11 such that the spray nozzle 12 can be opened at any time for filling liquid into the container 10 or installing/replacing the water absorption apparatus 20.

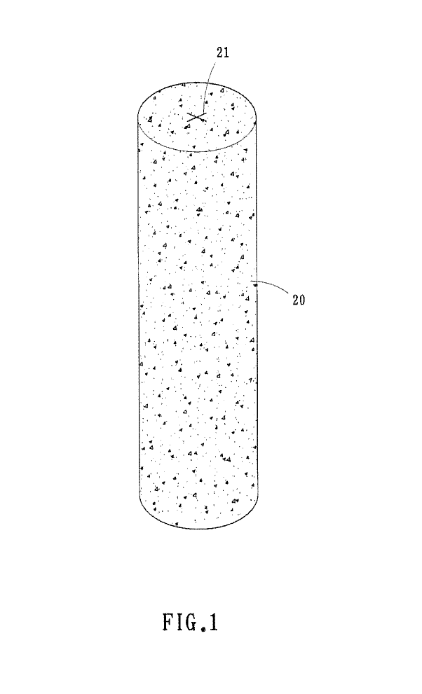

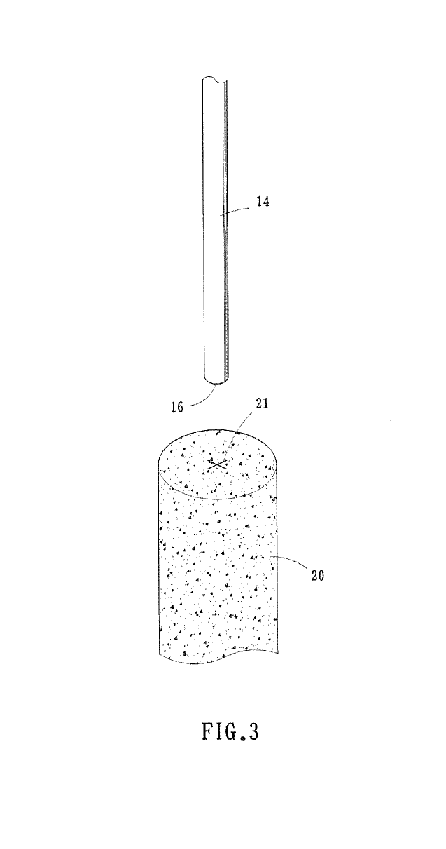

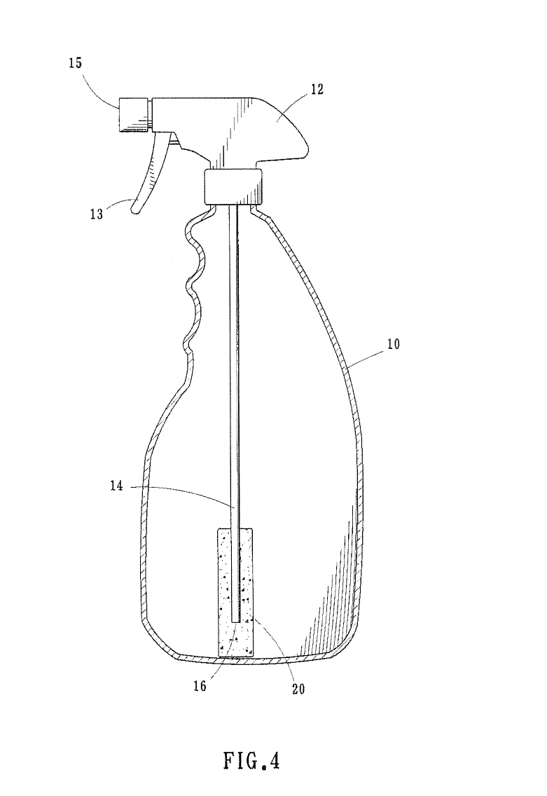

In addition, as shown in FIG. 2 and FIG. 3, the water absorbing apparatus 20 is made of a porous material with good water absorption as shown in the preferred embodiment in FIG. 1. The water absorbing apparatus 20 comprises a cutting slot 21 to allow the suction tube 14 at the bottom portion of the spray nozzle to insert into this cutting slot 21, as shown in FIG. 3, and such that the water absorbing apparatus 20 is attached to an outer portion of the suction inlet 16 at the rear end of the suction tube 14, as shown in FIG. 4.

Furthermore, as shown in FIG. 4, since the outer portion of the suction inlet 16 of the suction tube 14 is enclosed by the water absorbing apparatus 20, regardless the amount of the liquid inside the container 10, the suction inlet 16 of the suction tube 14 can be kept to maintain at a water saturation state by using the water absorption and retaining properties of the water absorbing apparatus 20 and such that when the container 10 is placed upside down or the container is tilted at any angles, the liquid can be sprayed out successfully via pressing on the pressure handle 13 without water supply blockages.

If the water spray container 10 is under an operation state of being placed upside down for a long period of time and the amount of the liquid inside the water absorbing apparatus 20 becomes less, the user only needs to place the water spray container 10 back to its upright position, the internal of the water absorbing apparatus 20 can then be refilled with the liquid again in a short period time without affecting the spraying operation.

The water absorbing apparatus 20 of the present invention can be made of any porous material with good water absorption such as sponge or it can be a porous material made of wooden fiber fabrics or plastic foam polymers such as foam sponge.

The water absorbing apparatus 20 is preferably to be of a circular column shape, and as shown in FIG. 1, FIG. 2 and FIG. 4, when it is installed to the rear end of the suction tube 14 and enclosing the outer portion of the suction inlet 16, the lower end of the water absorbing apparatus 20 is preferably in contact with a bottom surface of the inner portion of the container 10.

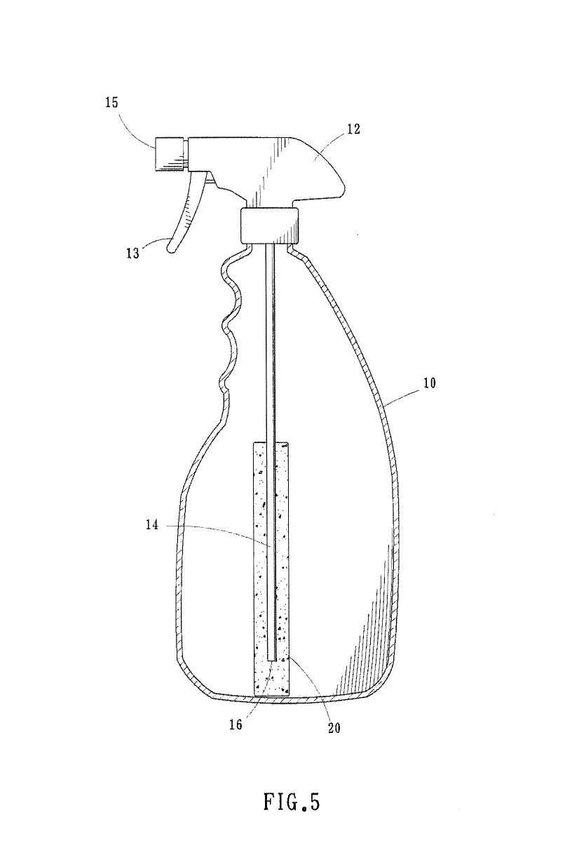

The length of the water absorbing apparatus 20 is not limited, and a longer water absorbing apparatus 20 can installed to the rear end of the suction tube 14, as shown in FIG. 5. Alternatively, a longer water absorbing apparatus 20 can be shortened prior to being installed to the rear end of the suction tube 14, as shown in FIG. 4. All of the above can be made by users with DIY operations.

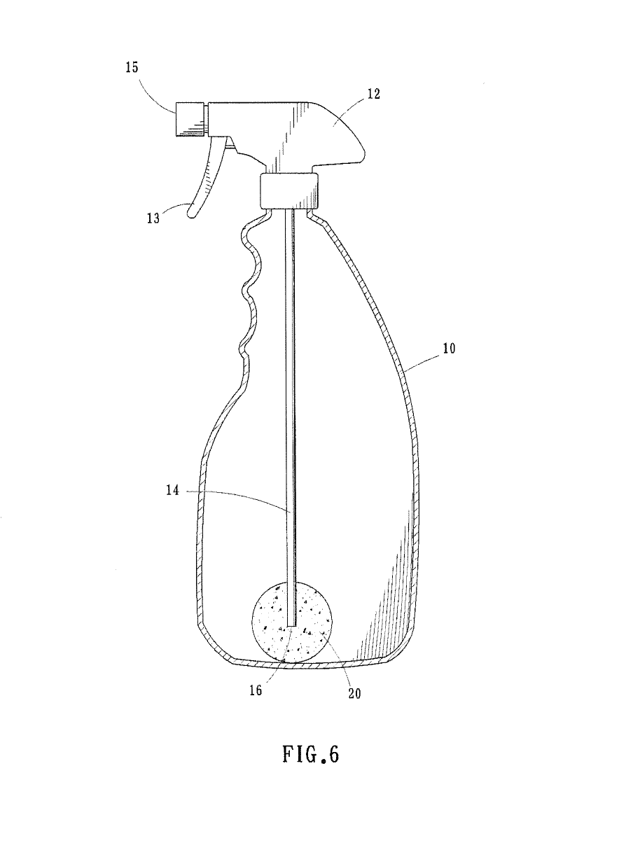

The water absorbing apparatus 20 of the present invention can also be made into different shapes to be installed to the rear end of the suction tube 14, as shown in FIG. 6, such that it can be used for different type of water spray containers 10 and different types of liquids in order to extend the scope of its useful applications.

In view of the above, the present invention is able to achieve the expected functions. In addition, a person skilled in the art may achieve the same based on the embodiments of the above description; however, the above embodiments are provided for illustrative purposes only and any modifications with equivalent effects shall be deemed to be within the spirit of the present invention, which are within the scope of the present invention.

1. A water absorbing apparatus for a water spray container, detachably installed in an internal of a container, and the container comprising:
a spray nozzle detachably installed on a container opening end, a piston pump pre-installed inside the spray nozzle, a pressure handle provided at a front end of the spray nozzle, a water outlet with a rotatable adjuster provided on top of the pressure handle, a suction tube connected to a bottom portion of the spray nozzle, allowing the spray nozzle to be opened at any time for filling a liquid into the container or for installing/replacing the water absorbing apparatus, characterized in that:
the water absorbing apparatus is made of a porous material with a good water absorption, and the water absorbing apparatus comprises a cutting slot such that the water absorbing device is installed at an outer portion of a suction inlet at a rear end of the suction tube inside the container in order to keep the suction inlet of the suction tube of the container to be maintained at a water saturation state.

2. The water absorbing device for a water spray container according to claim 1, wherein the water absorbing apparatus is preferably of a circular column shape.

3. The water absorbing apparatus for a water spray container according to claim 1, wherein the water absorbing apparatus is installed to the outer portion of the suction inlet at the rear end of the suction tube inside the container with a bottom surface of the water absorbing apparatus in contact with a bottom surface of the internal of the container.

4. The water absorbing apparatus for a water spray container according to claim 1, wherein the water absorbing apparatus is of a ball shape.
